(19) United States
(12) Patent Application Publication
(10) Pub. No.: US 2022/0343446 A1
(43) Pub. Date: Oct. 27, 2022

(54) SchooliT

(71) Applicant: Erkes Green, Lake Worth, FL (US)

(72) Inventor: Erkes Green, Lake Worth, FL (US)

(21) Appl. No.: 17/240,294

(22) Filed: Apr. 26, 2021

(51) Int. Cl. G06Q 50/20; G06Q 30/02; G06N 5/04

(52) U.S. Cl. CPC G06Q 50/205; G06Q 30/0201; G06N 5/04

(57) ABSTRACT

Disclosed is an artificial intelligence (AI) based system to monitor a plurality of activities of a student over a network. The artificial intelligence (AI) based system includes a memory and a processor. The memory stores machine-readable instructions pertaining to monitoring the activities of the student. The processor is coupled to the memory and operable to execute the machine-readable instructions stored in the memory. The processor is configured to capture the activity data of the student in real-time through a capture module. The processor is configured to analyze the activity data received from the capture module to assign a quantitative value corresponding to each of the activity data through an analysis module. The processor is configured to transmit the activity data analyzed by the analysis module to a computing device through a transmission module. The processor is configured to present the activity data through the computing device.

### FIELD OF THE INVENTION

The present invention relates to artificial intelligence (AI) based data processing and data analysis, in particular to artificial intelligence (AI) based system and method to monitor a plurality of activities of a student over a network.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

For many educational institutions and schools, tracking various student activities such as grades, attendance, the behavior is a time-consuming and tedious chore. Software systems to track student records of various types are known in the art. US patent U.S. Pat. No. 9,767,440B2 issued to Williams, et al. discloses a system and method for student attendance management are disclosed. A particular embodiment includes: installing a site-resident data collection module in a site location; using the site-resident data collection module to collect student information, attendance data, and other site data from the site location; transferring the site data to a host location; performing data transformation and normalization operations on the site data to convert the site data to a common format, the data transformation and normalization operations including district-specific data transformation rules; performing district configuration operations to configure rules specifying how and when alerts can be sent to recipients based on the site data; and performing scheduling and reporting operations to generate and distribute alerts, including attendance letters, to recipients based on the site data and the configured rules.

US patent U.S. Pat. No. 8,353,705B2 issued to Dobson, et al. an automated attendance monitoring system that includes (i) identification tags, with wireless communication capabilities, for each potential attendee, (ii) scanners for detecting the attendees' tags as they enter a given room, (iii) at least one server in communication with the scanners, (iv) handheld computing devices for use by attendance trackers, such as teachers, to verify a provisional attendance report generated by the scanners and server, and (v) software running on the server for receiving and managing the attendance data received from the scanners, and for generating attendance reports. Although particularly well-suited for tracking attendance in schools, the present invention can also be used in a variety of other settings where there is a need to track the whereabouts of a number of individuals.

However, the existing arts and systems only provide a raw outcome score for the student's activities and performances. These systems do not provide the level of effort or participation that a given student exhibits. Thus, parents or teachers of a student often do not know why their student may be performing poorly or exceptionally in certain areas, subjects, or classes.

It is also difficult for teachers to manually capture detailed records to identify reasons for weakness in a given student's performance.

This specification recognizes that there is a need for artificial intelligence (AI) based system to accurately and efficiently monitor various activities of the students.

Further limitations and disadvantages of conventional and traditional methods and systems will become apparent to one of skill in the art, through comparison of described methods and systems with some aspects of the present disclosure, as set forth in the remainder of the present application and with reference to the drawings and tables.

### SUMMARY

The present invention mainly solves the technical problems existing in the prior art. In response to these problems, the present invention provides an artificial intelligence (AI) based system to monitor a plurality of activities of a student over a network.

An aspect of the present disclosure relates to artificial intelligence (A) based system to monitor a plurality of activities of a student over a network. The artificial intelligence (AI) based system includes a memory and a processor. The memory stores machine-readable instructions pertaining to monitoring the activities of the student. The processor is coupled to the memory and operable to execute the machine-readable instructions stored in the memory. The processor is configured to capture the activity data of the student in real-time through a capture module. The processor is configured to analyze the activity data received from the capture module to assign a quantitative value corresponding to each of the activity data through an analysis module. The processor is configured to transmit the activity data analyzed by the analysis module to a computing device through a transmission module. The processor is configured to present the activity data through the computing device.

In an aspect, the activity data includes one or more of: school attendance data, school bus attendance data, social media data, eating data, physical movement data, school books data, yearbooks data, and school events data.

An aspect of the present disclosure relates to the artificial intelligence (AI) based method for monitoring a plurality of activities of a student over a network. The artificial intelligence (AI) based method includes a step of capturing, by one or more processors, activity data of the student in mal-time through a capture module. The artificial intelligence (AI) based method includes a step of analyzing, by one or more processors, the activity data received from the capture module to assign a quantitative value corresponding to each of the activity data through an analysis module. The artificial intelligence (AI) based method includes a step of transmitting, by one or more processors, the activity data analyzed by the analysis module to a computing device through a transmission module. The artificial intelligence (AI) based method includes a stop of presenting, by one or more processors, the activity data through the computing device.

In an aspect, the activity data includes one or more of: school attendance data, school bus attendance data, social media data, eating data, physical movement data, school books data, yearbooks data, and school events data.

Accordingly, one advantage of the present invention is that it enhances students learning skills, and allows the students to be in touch with teachers and parents on a web or software platform or a social media platform associated with the present system.

Accordingly, one advantage of the present invention is that it tracks records, school work, school/bus attendants, and social media in real-time.

Accordingly, one advantage of the present invention is that it provides an automated activity monitoring system that not only tracks grades as they enter or leave a classroom, but that also has robust means for ensuring the integrity of the attendance data, and that can prepare customized attendance and grade ports for use by schools and colleges.

Accordingly, one advantage of the present invention is that it monitors the eating habits of the students in school to stop obesity.

Accordingly, one advantage of the present invention is that it monitors and creates a social media platform where the students learn.

Accordingly, one advantage of the present invention is that it creates various e-books stored in a database of the social media platform to make an interactive ecosystem for the students, schools, parents, and teachers.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a network implementation of the present artificial intelligence (AI) based system to monitor a plurality of activities of a student over a network, in accordance with an embodiment of the present subject matter.

FIG. 2 illustrates the present artificial intelligence (AI) based system to monitor a plurality of activities of a student over a network, in accordance with an embodiment of the present subject matter.

FIG. 3 illustrates a flowchart of the artificial intelligence (AI) based method to monitor a plurality of activities of a student over a network, in accordance with at least one embodiment.

### DETAILED DESCRIPTION

Systems and methods are disclosed for monitoring activities of the students over a network. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose for monitoring a plurality of activities of a student over a network, it should be appreciated that the same has been done merely to illustrate the invention in an exemplary manner and any other purpose or function for which explained structures or configurations could be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein am for illustrative purposes and, thus, am not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory, or memory devices.

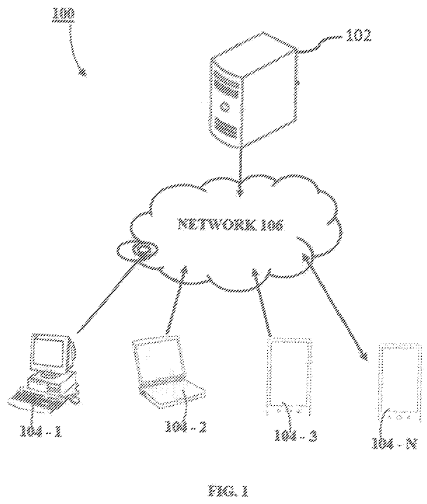

FIG. 1 illustrates a network implementation of the present artificial intelligence (AI) based system 100 to monitor a plurality of activities of a student over a network, in accordance with an embodiment of the present subject matter. Although the present subject matter is explained considering that the present artificial intelligence (AI) based system 100 is implemented on a server 102, it may be understood that the present artificial intelligence (AI) based system 100 may also be implemented in a variety of computing devices, such as a laptop computer, a desktop computer, a notebook, a workstation, a mainframe computer, a server, a network server, and the like. It will be understood that the present artificial intelligence (AI) based system 100 may be accessed by multiple users through one or more computing devices 104-1, 104-2 . . . 104-N, collectively referred to as computing device 104 hereinafter, or applications residing on the computing device 104. Examples of the computing device 104 may include but are not limited to, a portable computer, a personal digital assistant, a handheld or mobile device, smart devices, and a workstation. The computing devices 104 are communicatively accessible to the present artificial intelligence (AI) 100 through a network 106.

In one implementation, the network 106 may be a wireless network, a wired network, or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

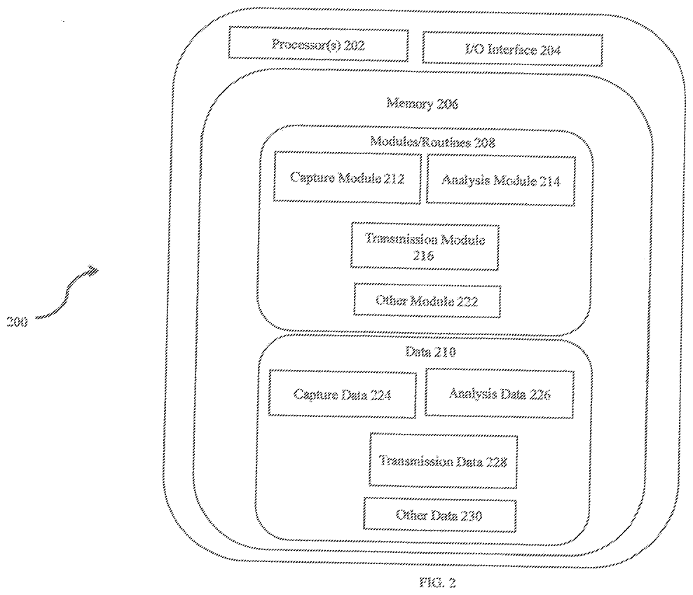

FIG. 2 illustrates a block diagram 200 of the present artificial intelligence (AI) based system to monitor a plurality of activities of a student over a network, in accordance with an embodiment of the present subject matter. FIG. 2 is explained in conjunction with FIG. 1. The artificial intelligence (AI) based system 102 may include at least one processor 202, an input/output (I/O) interface 204, and a memory 206.

The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 100 to interact with a user directly or through the computing device 104. Further, the I/O interface 204 may enable system 100 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The U/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a capture module 212, an analysis module 214, a transmission module 216, and other module 222. The other modules 222 may include programs or coded instructions that supplement applications and functions of the system 102.

The data 210, amongst other things, serves as a repository for storing data processed, received, and generated by one or more of the modules 208. The data 210 may also include a capture data 224, an analysis data 226, transmission data 228, and other data 230. The other data 230 may include data generated as a result of the execution of one or more modules in the other module 222.

In one implementation, processor 202 is configured to capture the activity data of the student in real-time through a capture module 212. In an embodiment, the activity data includes one or more of: school attendance data, school bus attendance data, social media data, eating data, physical movement data, school books data, yearbooks data, and school events data. The processor 202 is configured to analyze the activity data received from the capture module 212 to assign a quantitative value corresponding to each of the activity data through an analysis module 214. The processor 202 is configured to transmit the activity data analyzed by the analysis module 214 to a computing device 104 through a transmission module 216. The processor 202 is configured to present the activity data through the computing device 104.

According to an embodiment herein, the artificial intelligence (AI) based system 100 provides a web or software platform or a social media platform to allow the users such as parents, teachers, and students to interact in real-time. In an embodiment, the users can access the social media platform through a mobile application installed in their computing devices.

In an embodiment, the mobile application is based on one or more operating systems such as Android®, and iOS®. The artificial intelligence (AI) based system 100 requires the users to register on the mobile application by providing their credentials. Examples of the credentials including but not limited to a user name, password, age, gender, phone number, email address, location, school name, sections, subjects, registration number, etc. In an embodiment, the mobile application is commercialized as a software application or a mobile application, or a web application for monitoring the student's activities.

In an embodiment, the computing devices 104 of the user receive data from the server 102 which acts as a database as well to allow the parents and students to track the activity data. The data includes real-time information about the student's activity at education institutions. The database includes a multi-list of information for users to serve as an informational platform to allow for various selections/screens. This platform allows parents to send/receive alerts and monitor their kids' activities at school.

In one implementation, the mobile application presents the student's grades, extra-curricula activities such as sports, and bus trips to and from home. Additionally, the system can monitor social media activity also. Further, the mobile application displays two independent and separate classroom views for the students and teachers that depict the historical activity of the students in the school premises in real-time.

In an embodiment, the present artificial intelligence (AI) based system 100 uses various Artificial Intelligence and machine learning algorithms for analyzing and processing the activity data of the student. These algorithms include but are not limited to the Naive Bayes algorithm, Decision Tree algorithm, Random Forest algorithm, Support Vector Machines (SVM) algorithm, K Nearest Neighbours algorithm, Linear regression algorithm, Lasso Regression algorithm, and Logistic regression algorithm.

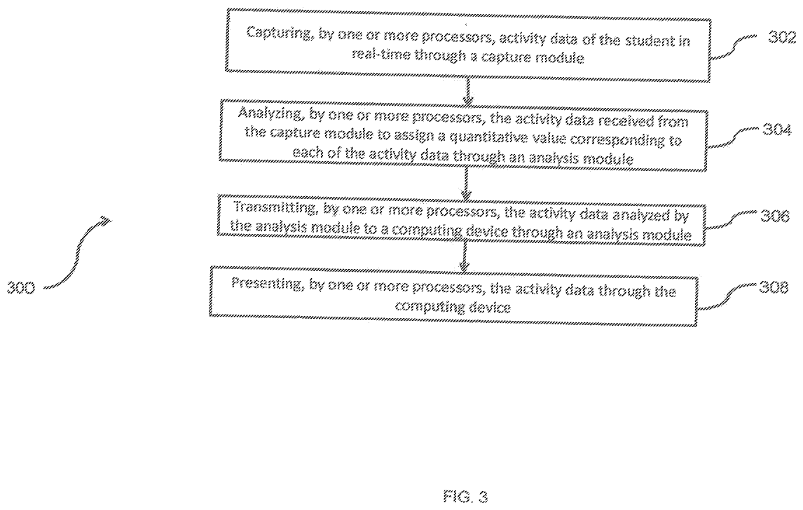

FIG. 3 illustrates a flowchart 300 of the artificial intelligence (AI) based method to monitor a plurality of activities of a student over a network, in accordance with at least one embodiment. The artificial intelligence (AJ) based method includes a step 302 of capturing, by one or more processors, activity data of the student in real-time through a capture module. The artificial intelligence (AI) based method includes a step 304 of analyzing, by one or more processors, the activity data received from the capture module to assign a quantitative value corresponding to each of the activity data through an analysis module. The artificial intelligence (AI) based method includes a step 306 of transmitting, by one or more processors, the activity data analyzed by the analysis module to a computing device through a transmission module. The artificial intelligence (A) based method includes a step 308 of presenting, by one or more processors, the activity data through the computing device. In an embodiment, the activity data includes one or more of: school attendance data, school bus attendance data, social media data, eating data, physical movement data, school books data, yearbooks data, and school events data.

Thus the present artificial intelligence (AI) based system and method provide an efficient, simpler, and more elegant framework for tracking records, school work, school/bus attendants, and social media in real-time. Further, the present artificial intelligence (AI) based system and method provide an automated activity monitoring system that not only tracks grades as they enter or leave a classroom, but that also has robust means for ensuring the integrity of the attendance data, and that can prepare customized attendance and grade reports for use by schools and colleges. Further, the present artificial intelligence (AI) based system and method monitor the eating habits of the students in school to stop obesity. Furthermore, the present artificial intelligence (AI) based system and method monitor and create the social media platform where the students learn. Additionally, the present artificial intelligence (AI) based system and method create various e-books stored in a database of the social media platform to make an interactive ecosystem for the students, schools, parents, and teachers.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

I/We claim:

1. An artificial intelligence (A) based system to monitor a plurality of activities of a student over a network, comprising:
a memory to store machine-readable instructions pertaining to monitoring the activities of the student; and
a processor coupled to the memory and operable to execute the machine-readable instructions stored in the memory, wherein the processor is configured to:
capture activity data of the student in real-time through a capture module;
analyze the activity data received from the capture module to assign a quantitative value corresponding to each of the activity data through an analysis module;
transmit the activity data analyzed by the analysis module to a computing device through a transmission; and
present the activity data through the computing device.

2. The artificial intelligence (AI) based system as claimed in claim 1, wherein the activity data includes one or more of: school attendance data, school bus attendance data, social media data, eating data, physical movement data, school books data, yearbooks data, and school events data.

3. An artificial intelligence (AI) based method for monitoring a plurality of activities of a student over a network, comprising:
capturing, by one or more processors, activity data of the student in real-time through a capture module;
analyzing, by one or more processors, the activity data received from the capture module to assign a quantitative value corresponding to each of the activity data through an analysis module;
transmitting, by one or mom processors, the activity data analyzed by the analysis module to a computing device through an analysis module; and
presenting, by one or more processors, the activity data through the computing device.

4. The artificial intelligence (AI) based method as claimed in claim 3, wherein the activity data includes one or more of school attendance data, school bus attendance data, social media data, eating data, physical movement data, school books data, yearbooks data, and school events data.
